(19) United States
(12) Patent Application Publication
(10) Pub. No.: US 2007/0046877 A1
(43) Pub. Date: Mar. 1, 2007

(54) MULTI-DOMAIN VERTICAL ALIGNMENT LIQUID CRYSTAL DISPLAY PANEL AND THIN FILM TRANSISTOR ARRAY THEREOF

(76) Inventors: Chen-Chi Lin, Chiayi County (TW); Kuang-Hsiang Lin, Taoyuan County (TW); Ching-Yi Chen, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/161,992

(22) Filed: Aug. 25, 2005

(51) Int. Cl. G02F 1/1337

(52) U.S. Cl. 349/129; 349/130

(57) ABSTRACT

A multi-domain vertical alignment liquid crystal display panel and a thin film transistor array thereof are provided. The thin film transistor array comprises a substrate, scan lines, data lines, thin film transistors, and pixel electrodes, wherein the scan lines, the data lines, the thin film transistors, and the pixel electrodes are disposed on the substrate. The scan lines and the data lines define a plurality of pixel regions on the substrate, and the pixel electrodes and the thin film transistors are disposed in the pixel regions. Each pixel electrode has a plurality of main slits and a plurality of fine slits disposed by the sides of the main slits. At least one end of each main slit in the periphery of the corresponding pixel electrode is curved for modifying the peripheral electric field of the pixel electrode, thus liquid crystal molecules can tilt in a regular direction.

### BACKGROUND OF THE INVENTION

1. Field of the Invention

The present invention generally relates to a display panel. More particularly, the present invention relates to a multi-domain vertical alignment liquid crystal display panel and a thin film transistor array thereof.

2. Description of Related Art

As multi-media technology advances, a variety of semiconductor devices or displays have been rapidly developed. The thin film transistor liquid crystal display (TFT-LCD) has such advantages as high resolution, high space-effectiveness, low power consumption and no radiation, and has become the main trend in this industry.

To date, the liquid crystal displays with high contrast ratio, no gray scale inversion, little color shift, high luminance, full color, high brightness, high responsive speed and wide view angle are required. In order to achieve the purpose of wide view angle, some displays, such as TN liquid crystal complying with wide viewing film display, in-plane switching display (IPS), fringe field switching display and multi-domain vertical alignment display (MAV), are developed to perform the purpose. Following are the descriptions of the conventional multi-domain vertical alignment liquid crystal display.

FIGS. 1A and 1B are cross-sectional views schematically illustrating a conventional MVA-LCD panel under off-state and on-state according to a driving voltage. Referring to FIG. 1A, the conventional MVA-LCD panel 100 comprises a color filter 102, a thin film transistor (TFT) array 104, a liquid crystal layer 106, and alignment protrusions 108. Wherein the liquid crystal layer 106, comprising a plurality of liquid crystal molecules 105, is disposed between the color filter 102 and the TFT array 104. In the off-state without applying the driving voltage (V=0), the major axis of the liquid crystal molecules 105 are perpendicular to the color filter 102 and the TFT array 104. Particularly, the liquid crystal molecules 105 nearby the alignment protrusions 108 possess a pre-tilt angle.

Referring to FIG. 1B, an electric field is generated between the color filter 102 and the TFT array 104 by applying the driving voltage (V≠0), and the liquid crystal molecules 105 is oriented along the direction of the electric field. Furthermore, as applying the driving voltage, the liquid crystal molecules 105 tilt in different directions by the alignment protrusions 108 on the color filter 102 and slits 112 of pixel electrodes 103 in the MVA-LCD panel 100 for providing a wide view angle.

FIG. 2 is another cross-sectional view schematically illustrating the MVA-LCD panel 100 shown in FIG. 1B. Referring to the boundary effect introduced in electromagnetism, the direction of the electric field at the edge of the pixel electrodes 103 is opposite to the electric field at other portion of the pixel electrodes 103, wherein a dummy alignment protrusion 114 disposing at the edge of the pixel electrodes 103 can be proposed. Owing to different tilting directions of the liquid crystal molecules 105 at the edge of the pixel electrodes 103, a disclination may be generated in region 116. Furthermore, the light transmission of the MVA-LCD panel 100 goes inferior, and the response time increases.

### SUMMARY OF THE INVENTION

Accordingly, the present invention is directed to a TFT array for improving light transmission, contrast ratio, and response speed of a display panel.

The present invention is also directed to a MVA-LCD panel, which has superior light transmission, contrast ratio, response speed, and thus provides fine display quality.

The present invention provides a TFT array, which comprises a substrate; a plurality of scan lines, disposed on the substrate; a plurality of data lines, disposed on the substrate, wherein the scan lines and the data lines define a plurality of pixel regions on the substrate; a plurality of TFTs, disposed on the substrate, wherein each TFT is disposed in one of the pixel regions and driven by the corresponding scan line and the corresponding data line; and a plurality of pixel electrodes, disposed on the substrate, wherein each pixel electrode is located in one of the pixel regions and coupled to the corresponding TFT. In addition, each pixel electrode has a plurality of main slits and a plurality of fine slits disposed by the sides of the main slits, wherein at least one end of each main slit in the periphery of the corresponding pixel electrode is curved.

The present invention also provides a multi-domain vertical alignment (MVA) liquid crystal display (LCD) panel, which comprises the TFT array mentioned above, a color filter, and a liquid crystal layer. Wherein, the color filter is disposed over the TFT array, and the liquid crystal layer is disposed between the TFT array and the color filter.

According to an embodiment of the present invention, the end of each main slit is curved at a deflection angle between 0 degree and 45 degree.

According to an embodiment of the present invention, each curved end takes a zigzag shape.

According to an embodiment of the present invention, the MVA-LCD panel further comprising a plurality of alignment protrusions, which are disposed on the color filter. For example, the alignment protrusions may take stripe shapes and are parallel to the alignment protrusions. In addition, each alignment protrusion may have at least one branch, and the branches of the alignment protrusions are corresponding to the edges of the pixel electrodes.

The present invention is capable of reducing the region of disclination in the MVA-LCD panel and increasing the aperture ratio of the display panel without any additional process and cost. Furthermore, the contrast ratio and the response time of the displaying image can also be improved.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A and 1B are cross-sectional views schematically illustrating a conventional MVA-LCD panel under off-state and on-state according to a driving voltage.

FIG. 2 is another cross-sectional view schematically illustrating the MVA-LCD panel shown in FIG. 1B.

FIG. 3A is a cross-sectional view schematically illustrating a MVA-LCD panel according to an embodiment of the present invention.

FIG. 3B is a top view schematically illustrating a TFT array shown in FIG. 3A.

FIG. 4 is a cross-sectional view of the MVA-LCD panel, as shown in FIG. 3B, having alignment protrusions correspondingly disposed over the TFT array.

FIG. 5 is a cross-sectional view schematically illustrating a MVA-LCD panel having alignment protrusions shown in FIG. 4.

FIG. 6 is a cross-sectional view schematically illustrating a MVA-LCD panel according to another embodiment of the present invention, wherein the alignment protrusions are correspondingly disposed over the TFT array.

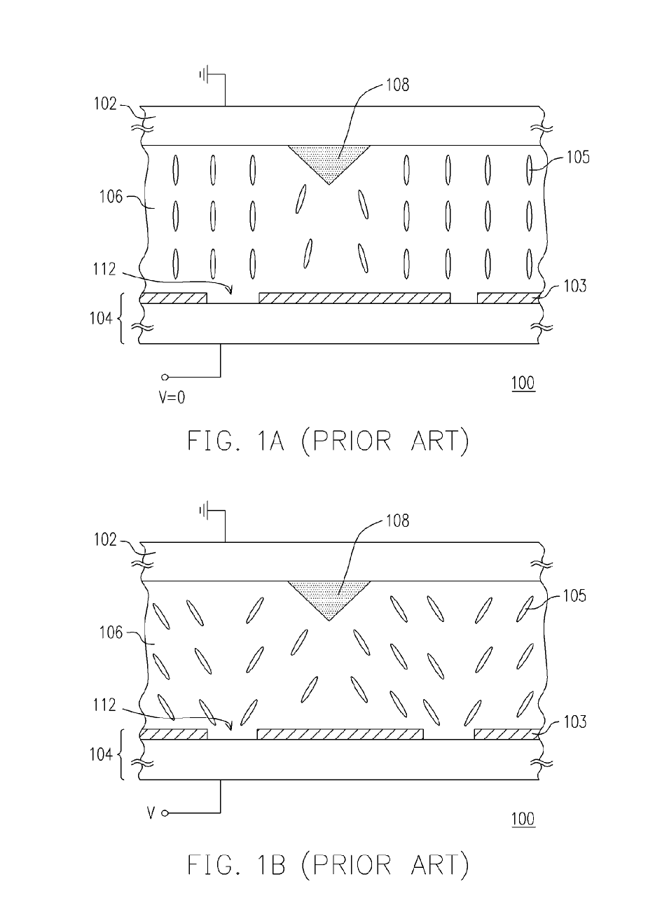

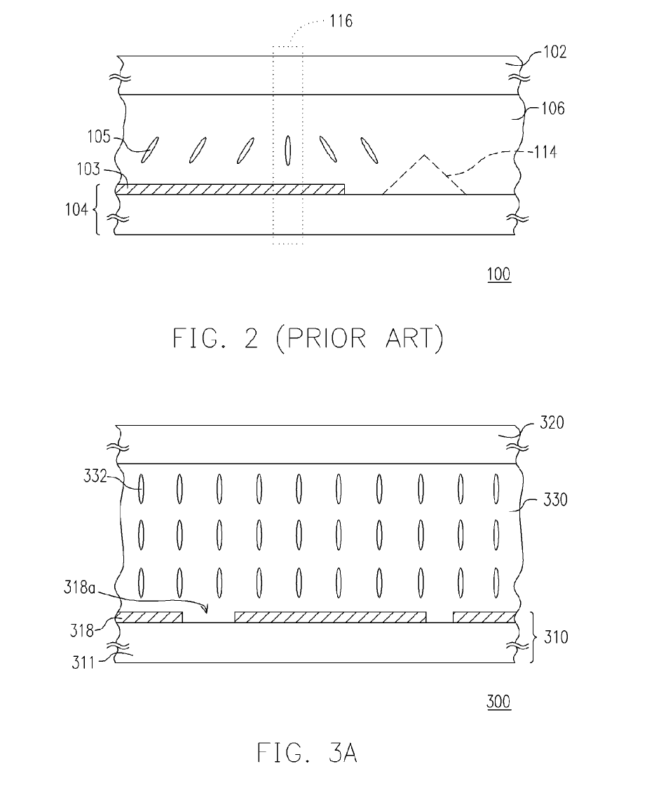

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

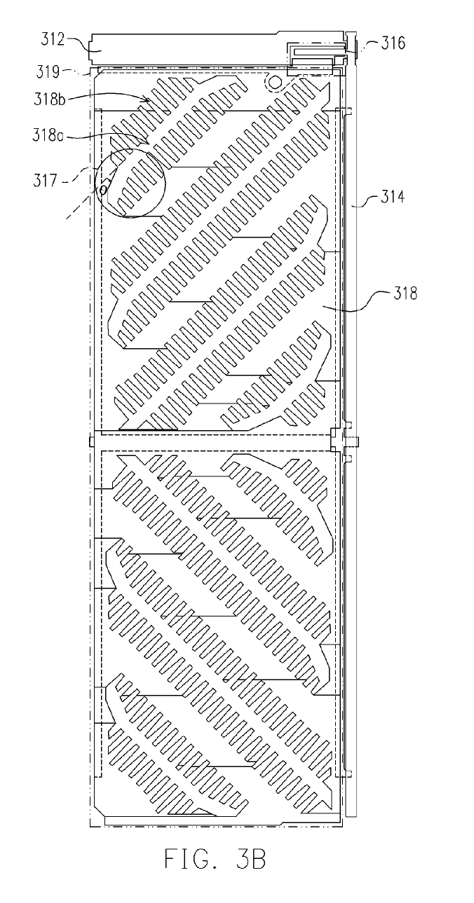

FIG. 3A is a cross-sectional view schematically illustrating a MVA-LCD panel according to an embodiment of the present invention. FIG. 3B is a top view schematically illustrating a TFT array shown in FIG. 3A. Referring to FIG. 3A, the MVA-LCD panel 300 mainly comprises a TFT array 310, a color filter 320, and a liquid crystal layer 330. Wherein, the color filter 320 is parallel to the TFT array 310, and the liquid crystal layer 330, comprising a plurality of liquid crystal molecules 332, is disposed between the color filter 320 and the TFT array 310.

Referring to both FIGS. 3A and 3B, the TFT array mainly comprises a substrate 311, a plurality of scan lines 312, a plurality of data lines 314, a plurality of TFTs 316, and a plurality of pixel electrodes 318. Wherein, the scan lines 312 and the data lines 314 define a plurality of pixel regions 319 on the substrate 311, and the TFTs 316 and the pixel electrodes 318 are disposed in the pixel regions 319. The pixel electrodes 318 are coupled to the TFTs 316, and the TFTs 316 are driven by the scan lines 312 and the data lines 314.

Referring to FIG. 3B, each pixel electrode 318 has a plurality of main slits 318a and a plurality of fine slits 318b disposed by the sides of the main slits 318a. The fine slits 318b are capable of improving the response time of the MVA-LCD panel 300. It should be noted that each main slit 318a has at least one curved end 317. Specifically, the main slit 318a in the periphery of the corresponding pixel electrode 318 is curved, wherein the curved end 317 has a deflection angle Θ between 0 degree and 45 degree.

According to the embodiment mentioned above, as applying a driving voltage between the color filter 320 and the TFT array 330, the generated electric fields at the edge of the pixel electrodes 318 are modified by the effect of the curved ends 317. Therefore, the liquid crystal molecules 332 at the edge of the pixel electrodes 318 tilt in a regular direction, thus the phenomenon of disclination can be prevented.

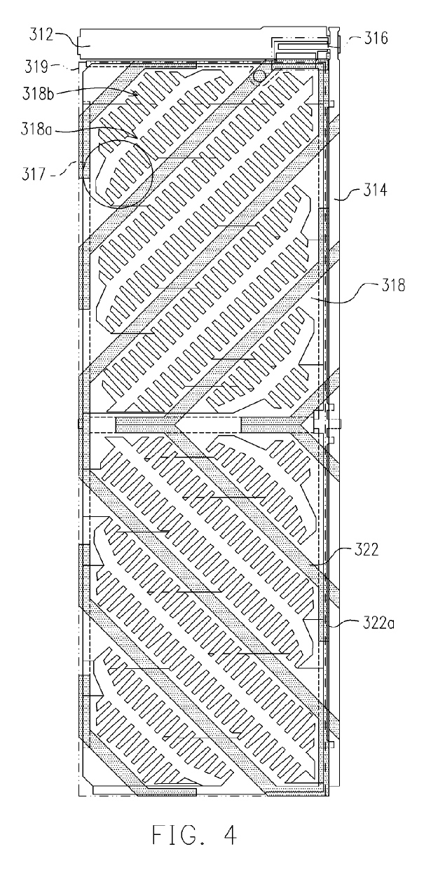

FIG. 4 is a cross-sectional view of the MVA-LCD panel, as shown in FIG. 3B, having alignment protrusions correspondingly disposed over the TFT array. Referring to FIG. 4, besides using the curved ends 318b of the main slits 318a in the periphery of the pixel electrodes 318, the present invention can further forming alignment protrusions 322 with branches 322a on the color filter 320, as shown in FIG. 3A, for diminishing the disclination. Wherein, the alignment protrusions 322 are parallel to the main slits 418a of the pixel electrodes 418, and the branches 322a of the alignment protrusions 322 are corresponding to the edge of the pixel electrodes 318.

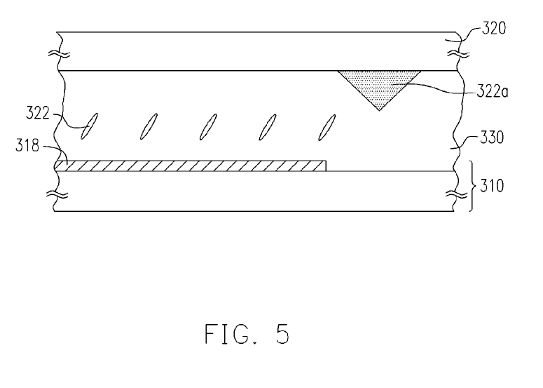

FIG. 5 is a cross-sectional view schematically illustrating a MVA-LCD panel having alignment protrusions 322 shown in FIG. 4. Referring to FIGS. 4 and 5, the pixel electrodes 318 have the main slits 318a and the alignment protrusions 322 are disposed on the color filter 320. It should be noted that the direction of the electric fields at the edge of the pixel electrodes 318 can further be modified only by using the branches 322a of the alignment protrusions 322 and without forming any curved ends 317 of the main slits 318a. The liquid crystal molecules 332 at the edge of the pixel electrodes 318 can still tilt in a regular direction, thus the phenomenon of disclination can also be prevented.

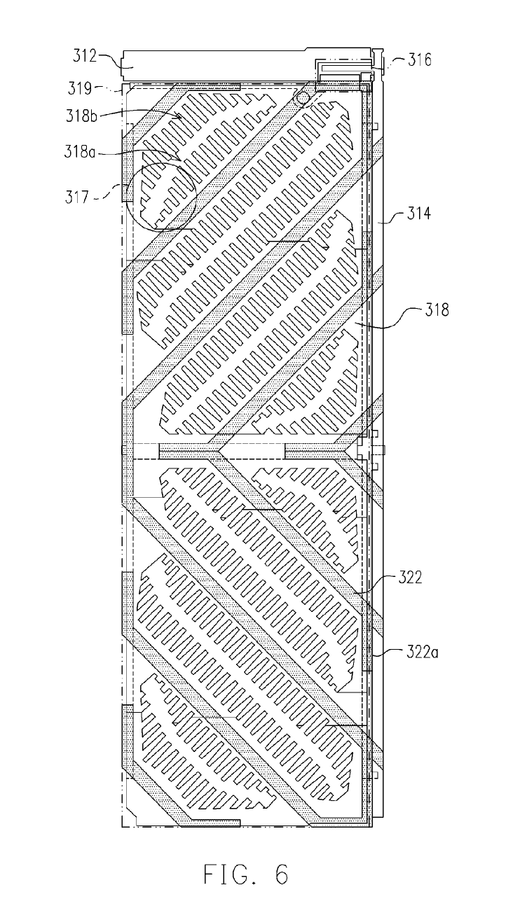

FIG. 6 is a cross-sectional view schematically illustrating a MVA-LCD panel according to another embodiment of the present invention, wherein the alignment protrusions are correspondingly disposed over the TFT array. Referring to FIG. 6, the curved ends 317 of the main slits 318a can further take zigzag shapes, which can also achieve the purposes of the present invention as the previous embodiment mentioned above. Certainly, the type of the curved ends 317 of the main slits 318a in the present invention is not limited, and one of ordinary skill in the art may select the type of the curved ends 317 according to a preferred process.

The present invention forms the curve ends of the pixel electrodes for orienting the liquid crystal molecules along a regular direction and thus preventing the phenomenon of the disclination at the edge of the pixel electrode. Furthermore, the present invention can form the slits having curved ends on the pixel electrodes by simply modifying the pattern of the conventional mask. In other words, the present invention is capable of reducing the region of disclination in the MVA-LCD panel and increasing the aperture ratio of the display panel without any additional process and cost. Furthermore, the contrast ratio and the response time of the displaying image can also be improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A thin film transistor array, comprising:
a substrate;
a plurality of scan lines, disposed on the substrate;
a plurality of data lines, disposed on the substrate, wherein the scan lines and the data lines define a plurality of pixel regions on the substrate;
a plurality of thin film transistors, disposed on the substrate, wherein each thin film transistor is disposed in one of the pixel regions and driven by the corresponding scan line and the corresponding data line; and
a plurality of pixel electrodes, disposed on the substrate, wherein each pixel electrode is located in one of the pixel regions and coupled to the corresponding thin film transistor, and each pixel electrode has a plurality of main slits and a plurality of fine slits disposed by the sides of the main slits, wherein at least one end of each main slit in the periphery of the corresponding pixel electrode is curved.

2. The thin film transistor array according to claim 1, wherein the end of each main slit is curved at a deflection angle between 0 degree and 45 degree.

3. The thin film transistor array according to claim 1, wherein each curved end takes a zigzag shape.

4. A multi-domain vertical alignment liquid crystal display panel, comprising:
a thin film transistor array, comprising:
a substrate;
a plurality of scan lines, disposed on the substrate;
a plurality of data lines, disposed on the substrate, wherein the scan lines and the data lines define a plurality of pixel regions on the substrate;
a plurality of thin film transistors, disposed on the substrate, wherein each thin film transistor is disposed in one of the pixel regions and driven by the corresponding scan line and the corresponding data line;
a plurality of pixel electrodes, disposed on the substrate, wherein each pixel electrode is located in one of the pixel regions and coupled to the corresponding thin film transistor, and each pixel electrode has a plurality of main slits and a plurality of fine slits disposed by the sides of the main slits, wherein at least one end of each main slit in the periphery of the corresponding pixel electrode is curved;
a color filter, disposed over the thin film transistor array; and
a liquid crystal layer, disposed between the thin film transistor array and the color filter.

5. The multi-domain vertical alignment liquid crystal display panel according to claim 4, wherein the end of each main slit is curved at a deflection angle between 0 degree and 45 degree.

6. The multi-domain vertical alignment liquid crystal display panel according to claim 4, wherein each curved end takes a zigzag shape.

7. The multi-domain vertical alignment liquid crystal display panel according to claim 4, further comprising a plurality of alignment protrusions, which are disposed on the color filter.

8. The multi-domain vertical alignment liquid crystal display panel according to claim 7, wherein the alignment protrusions take stripe shapes and are parallel to the alignment protrusions.

9. The multi-domain vertical alignment liquid crystal display panel according to claim 7, wherein each alignment protrusion has at least one branch, and the branches of the alignment protrusions are corresponding to the edges of the pixel electrodes.
